(19) United States
(12) Patent Application Publication
(10) Pub. No.: US 2024/0370539 A1
(43) Pub. Date: Nov. 7, 2024

(54) PHYSICAL STATE CHANGE AUTHENTICATION METHODS

(71) Applicant: T-MOBILE INNOVATIONS LLC, Overland Park, KS (US)

(72) Inventors: Peter Philip MYRON, New Braunfels, TX (US); Michael John MITCHELL, North Bend, WA (US)

(21) Appl. No.: 18/143,423

(22) Filed: May 4, 2023

(51) Int. Cl. G06F 21/31

(52) U.S. Cl. CPC G06F 21/316

(57) ABSTRACT

Systems, methods, and computer-readable media are provided for leveraging physical state changes of user equipment (UE) for authentication. A series of unlock gestures comprising physical state changes are received via one or more sensors of the UE. The physical state changes may comprise detecting location of the UE, changes to movement of the UE, changes to orientation of the UE, contact with the UE, a volume of audible signals, or an intensity of light. After the series of unlock gestures are interpreted at the UE, at least a portion of the UE is unlocked to perform a specific action. The specific action may comprise unlocking the UE, opening an application on the UE, causing the UE to communicate information to another device, causing fake information to be displayed by the UE, causing sensitive information to be encrypted or unavailable, or blocking a portion of functionality of the UE.

### SUMMARY

A high-level overview of various aspects of the invention is provided here as an overview of the disclosure and to introduce a selection of concepts further described below in the detailed description. This summary is not intended to identify key features or essential features of the claimed subject matter, nor is it intended to be used as an aid in isolation to determine the scope of the claimed subject matter.

In brief and at a high level, this disclosure describes, among other things, systems, methods, and computer-readable media that leverage physical state changes of user equipment (UE) for authentication. More particularly, additional steps can be added into the authentication process that are pass-actions (also referred to herein as physical state changes) rather than pass-words.

Initially, a series of unlock gestures comprising a plurality of physical state changes are received via one or more sensors of the UE. For example, the physical state changes may comprise one or more of detecting location of the UE, changes to movement of the UE, changes to orientation of the UE, contact with the UE, a volume of audible signals, or an intensity of light. After the series of unlock gestures are interpreted at the UE, at least a portion of the UE is unlocked to perform a specific action corresponding to the interpreting. The specific action may comprise unlocking the UE, opening an application on the UE, causing the UE to communicate information to another device, causing fake information to be displayed by the UE, causing sensitive information to be encrypted or unavailable, or blocking a portion of functionality of the UE.

### BRIEF DESCRIPTION OF THE SEVERAL VIEWS OF THE DRAWINGS

Illustrative embodiments of the present invention are described in detail below with reference to the attached drawing figures, and wherein:

FIG. 1 depicts a schematic for an exemplary system, in accordance with an embodiment of the present invention;

FIG. 2 depicts a diagram of a physical state change engine, in accordance with aspects herein;

FIG. 3 depicts an exemplary method for unlocking at least a portion of the UE to perform specific action corresponding to the series of unlock gestures, in accordance with aspects herein; and

FIG. 4 depicts an exemplary computing device suitable for use in implementations of aspects herein.

### DETAILED DESCRIPTION

The subject matter of select embodiments of the present invention is described with specificity herein to meet statutory requirements. The Detailed Description is not intended to define what is regarded as the invention, which is the purpose of the claims. The claimed subject matter might be embodied in other ways to include different steps or combinations of steps similar to the ones described in this document, in conjunction with other present or future technologies. Terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention. The following is a list of these acronyms:
AWS Advanced Wireless Services
BRS Broadband Radio Service
BTS Base Transceiver Station
CDMA Code Division Multiple Access
EBS Educational Broadband Services
eNodeB Evolved Node B
EVDO Evolution-Data Optimized
gNodeB Next Generation Node B
GPS Global Positioning System
GSM Global System for Mobile Communications
HRPD High Rate Packet Data
eHRPD Enhanced High Rate Packet Data
LTE Long Term Evolution
LTE-A Long Term Evolution Advanced
PCS Broadband Personal Communications Service
RNC Radio Network Controller
SyncE Synchronous Ethernet
TDM Time-Division Multiplexing
VOIP Voice Over Internet Protocol
WAN Wide Area Network
WCS Wireless Communications Service
WiMAX Worldwide Interoperability for Microwave Access

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the present technology may be embodied as, among other things, a method, system, or computer-program product. Accordingly, the embodiments may take the form of a hardware embodiment, or an embodiment combining software and hardware. An embodiment takes the form of a computer-program product that includes computer-usable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-usable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-usable instructions—including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, the world is becoming more connected than ever before as it depends on communication and access across time zones, geographic borders, and language barriers. Cybersecurity provides confidence and trust for this online activity but is constantly under assault from a variety of threats. Phishing scams are one of the most common threats that cybercriminals use to impersonate legitimate organizations or persons in an attempt to trick users into clicking embedded links or download attachments. Once tricked, the cybercriminals have a backdoor into the user's system to steal credentials. Malware scams enable cybercriminals to use keylogging malware track strokes typed into a keyboard or pin pad, spying malware to watch and record, or other malware that runs in the background and collects data via browser caches. Large scale data breaches are also becoming more common that often result in the online publication of extensive lists of user names, passwords, and other valuable information. Brute force attacks are also possible because simple PIN or text passwords are relatively easy to break, especially those with low entropy.

At a high level, systems, methods, and computer-readable media of the present invention leverage physical state changes of user equipment (UE) for authentication. More particularly, additional steps can be added into the authentication process that are pass-actions (also referred to herein as physical state changes) rather than pass-words. These pass-actions are not breakable by traditional means currently used by cybercriminals and can provide varying degrees of access to the UE.

Initially, a series of unlock gestures comprising a plurality of physical state changes are received via one or more sensors of the UE. For example, the physical state changes may comprise one or more of detecting location of the UE, changes to movement of the UE, changes to orientation of the UE, contact with the UE, a volume of audible signals, or an intensity of light. After the series of unlock gestures are interpreted at the UE, at least a portion of the UE is unlocked to perform a specific action corresponding to the interpreting. The specific action may comprise unlocking the UE, opening an application on the UE, causing the UE to communicate information to another device, causing fake information to be displayed by the UE, causing sensitive information to be encrypted or unavailable, or blocking a portion of functionality of the UE. In this way, aspects herein provide additional steps into the authentication process to increase security and stifle some remote password-hacking attempts.

For example, the user may set an unlock password defined by a series of unlock gestures: 1) the user lifts the UE above his head; 2) the user spins around twice; 3) the user coughs into the UE; 4) the user slaps the bottom of the UE; 5) the user does a finger-pop from his mouth; and 6) the user yells “Aaaaaaaaaahhhh!” Various sensors on the UE detect these physical state changes and interprets them as an unlock password. Accordingly, the UE is unlocked. As can be appreciated, a remote hacking attempt cannot be accomplished by the cybercriminal with this particular unlock password.

Accordingly, in a first aspect of the present invention, computer-readable media is provided, the computer-readable media having computer-executable instructions embodied thereon that, when executed, perform a method for leveraging physical state changes of a UE for authentication. The method includes receiving, via one or more sensors of the UE, a series of unlock gestures. The series of unlock gestures comprises a plurality of physical state changes. The method also comprises interpreting the series of unlock gestures at the UE. The method further comprises unlocking at least a portion of the UE to perform a specific action corresponding to the interpreting.

In a second aspect of the present invention, a method for leveraging physical state changes of a UE for authentication is provided. The method includes receiving, via one or more sensors of the UE, a series of unlock gesture. The series of unlock gestures comprises a plurality of physical state changes. The method also comprises interpreting the series of unlock gestures at the UE. The method further unlocking at least a portion of the UE to perform a specific action corresponding to the interpreting.

In a third aspect of the present invention, a system for leveraging physical state changes of UE for authentication is provided. The system comprises at least one processor and one or more computer storage media storing computer-readable instructions that when executed by the at least one processor, cause the at least one processor to perform operations. The operations comprise receiving, via one or more sensors of the UE, a series of unlock gestures. The series of unlock gestures comprises a plurality of physical state changes. The operations also comprise interpreting the series of unlock gestures at the UE. The operations further comprise selecting a specific action corresponding to the interpreting. The specific action comprises one of unlocking the UE, opening an application on the UE, causing the UE to communicate information to another device, causing fake information to be displayed by the UE, causing sensitive information to be encrypted or unavailable, or blocking a portion of functionality of the UE. The operations also comprise performing the specific action.

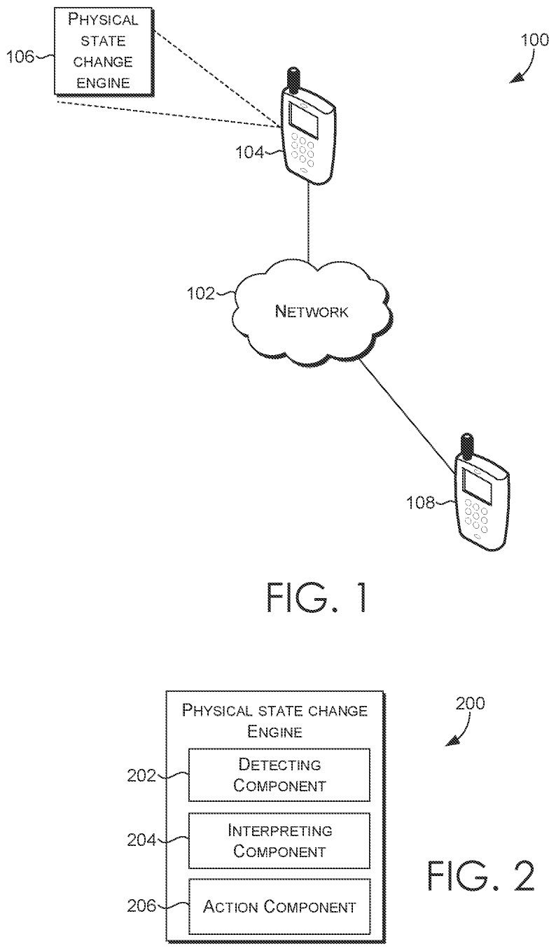

Turning to FIG. 1, a network environment suitable for use in implementing embodiments of the present disclosure is provided. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

As shown in FIG. 1, a communications device may be a UE 104. In the network environment 100, UE 104 may communicate with other devices, such as mobile devices (e.g., UE 108), servers, etc. The UE 104 may take on a variety of forms, such as a personal computer, a laptop computer, a tablet, a netbook, a mobile phone, a Smart phone, a personal digital assistant, or any other device capable of communicating with other devices.

For example, the UE 104 may take on any form such as, for example, a mobile device or any other computing device capable of wirelessly communication with the other devices using a network. Makers of illustrative devices include, for example, Research in Motion, Creative Technologies Corp., Samsung, Apple Computer, and the like. A device can include, for example, a display(s), a power source(s) (e.g., a battery), a data store(s), a speaker(s), memory, a buffer(s), and the like. In embodiments, UE 104 comprises a wireless or mobile device with which a wireless telecommunication network(s) can be utilized for communication (e.g., voice and/or data communication). In this regard, the UE 104 can be any mobile computing device that communicates by way of, for example, a 5G network.

The UE 104 may utilize network 102 to communicate with other computing devices (e.g., mobile device(s), a server(s), a personal computer(s), etc.) such as UE 108. In some aspects, network 102 comprises a local area network (LAN) and/or a wide area network (WAN). Such networking environments are commonplace in offices, enterprise-wide computer networks, intranets, and the Internet. In some aspects, network 102 is a telecommunications network, or a portion thereof. A telecommunications network might include an array of devices or components, some of which are not shown so as to not obscure more relevant aspects of the invention. Components such as terminals, links, and nodes (as well as other components) may provide connectivity in some embodiments. Network 102 may include multiple networks, as well as being a network of networks, but is shown in more simple form so as to not obscure other aspects of the present disclosure. Network 102 may be part of a telecommunications network that connects subscribers to their immediate service provider. In embodiments, network 102 is associated with a telecommunications provider that provides services to user devices, such as UE 104. For example, network 102 may provide voice services to user devices or corresponding users that are registered or subscribed to utilize the services provided by a telecommunications provider. Although it is contemplated network 102 can be any communication network providing voice and/or data service(s), such as, for example, a 1× circuit voice, a 3G network (e.g., CDMA, CDMA1000, WCDMA, GSM, UMTS), a 4G network (WiMAX, LTE, HSDPA), a 5G network, or the like.

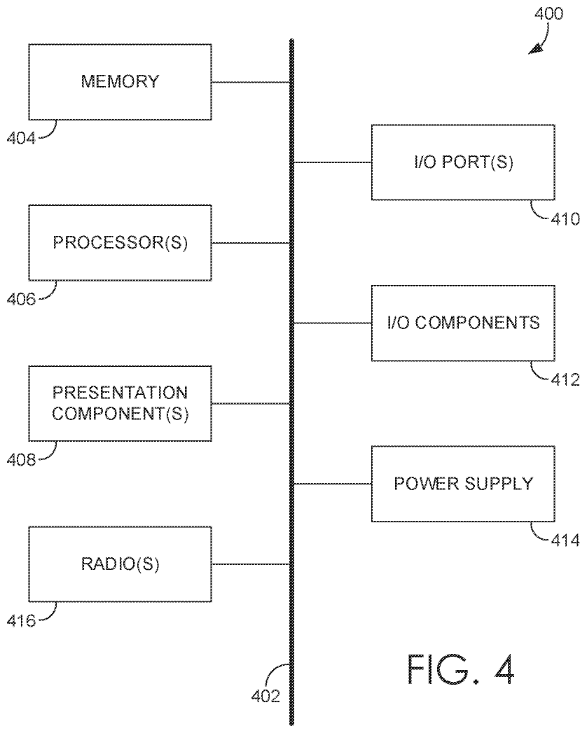

The network environment 100 may include a database (not shown). The database may be similar to the memory component 412 in FIG. 4 and can be any type of medium that is capable of storing information. The database can be any collection of records (e.g., network or device information). In one embodiment, the database includes a set of embodied computer-executable instructions that, when executed, facilitate various aspects disclosed herein. These embodied instructions will variously be referred to as “instructions” or an “application” for short.

Continuing, the network environment 100 may further include a physical state change engine 106. The physical state change engine 106 may be configured to, among other things, initiate a physical state change engine 106, in accordance with the present disclosure. Though the physical state change engine 106 is illustrated as a component of UE 104 in FIG. 1, it may be a standalone device (e.g., a server having one or more processors), a component of the UE 104, an application or service corresponding provided via the network 102, may be remotely located, or any combination thereof.

Referring now to FIG. 2, the physical state change engine 106 may include, among other things, detecting component 202, interpreting component 204, and action component 206. The physical state change engine 106 may communicate data to or receive data from user devices, such as UE 104 and/or UE 108.

Detecting component 202 generally receives, via one or more sensors of the UE, a series of unlock gestures. The series of unlock gestures comprise a plurality of physical state changes detected by the one or more sensors of the UE. For example, one sensor of the UE may detect a location of the UE. Another sensor may detect changes to movement of the UE. Yet another sensor may detect changes to orientation of the UE. Other sensors may detect contact with the UE, a volume of audible signals, and/or an intensity of light.

Interpreting component 204 generally interprets the series of unlock gestures at the UE. For example, a user may set an unlock password as a first series of unlock gestures comprising: 1) tapping the phone three times; 2) rotating the phone one hundred eighty degrees; 3) putting the phone in his pocket; 4) pulling the phone out of his pocket; and 5) whispering “Open.” The user may also set a password comprising a second series of unlock gestures that opens the phone in a protected mode so banking, email, social media, and instant messaging applications are encrypted or not available for the user to open. The user may set an encrypted mode password as a second series of gestures comprising: 1) putting the phone face down on a surface; 2) picking the phone up and raising it above his head; and yelling “Safe mode!” As can be appreciated, the user can set any number of passwords comprising different series of gestures to perform different actions. Once defined, the interpreting component 204 interprets the series of gestures received by the detecting component 202 to select what action, if any, is to be performed.

Action component 206 generally unlocks at least a portion of the UE to perform a specific action corresponding to the interpreting of the interpreting component 204. Various actions may be performed to facilitate rubber hose encryption, parental control, geolocation based control, and the like. In one aspect, action component 206 opens an application on the UE. In another aspect, action component 206 causes the UE to communicate information to another device (e.g., sharing images or other content).

In another aspect, action component 206 causes fake information to be displayed by the UE (e.g., bank account login, balance information, etc.). For example, a criminal may attempt to force the user to open his UE for the criminal to initiate a transaction. By causing fake information or an alternative interface to be displayed, the user can be protected from various forms of theft. For example, the fake information may minimize a balance of a bank account associated with the user. This makes it appear to the criminal that the user may not be a good target for a fraudulent transaction. If the criminal or user initiates a transaction, the fake information may falsely indicate that a transaction has been processed so the criminal does not suspect he has been tricked. Similarly, action component 206 can cause sensitive information to be encrypted or unavailable to further protect the user.

In yet another aspect, action component 206 can block a portion of functionality of the UE. For example, detect component 202 may detect the UE is moving rapidly and interpret component 204 may interpret that to mean the user is traveling on an airplane. Accordingly, action component 206 may put the UE in airplane mode to block cellular usage.

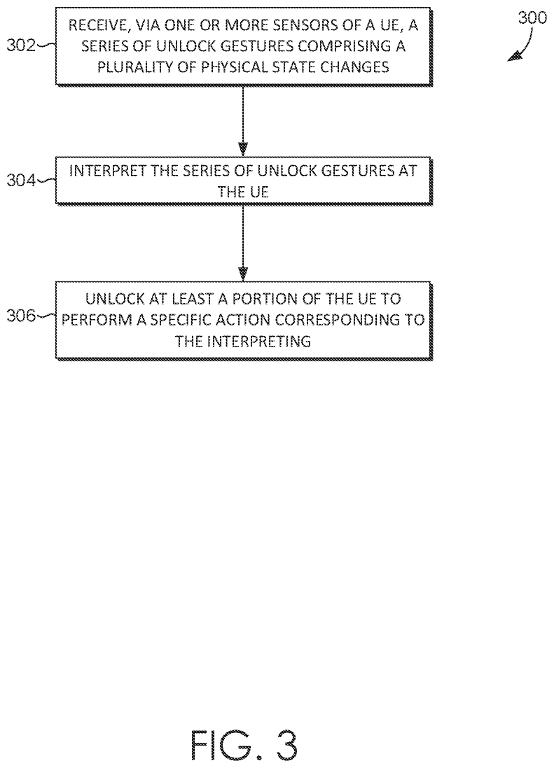

Turning now to FIG. 3, flow diagram depicting an exemplary method 300 for unlocking at least a portion of the UE to perform specific action corresponding to the series of unlock gestures is provided, in accordance with aspects of the present invention. Method 300 may be performed by any computing device (such as computing device described with respect to FIG. 4) with access to a physical state change engine (such as the one described with respect to FIG. 2) or by one or more components of the network environment described with respect to FIG. 1 (such as UE 102 and/or physical state change engine 106).

Initially at step 302, a series of unlock gestures comprising a plurality of physical state changes is received via one or more sensors of a UE. The one or more sensors may detect: location of the UE, changes to movement of the UE, changes to orientation of the UE, contact with the UE, a volume of audible signals, or an intensity of light.

At step 304, the series of unlock gestures is interpreted at the UE. By way of example, the user may have set various pass-actions on the UE to perform different specific actions. Once the unlock gestures are received, they are interpreted to determine what action, if any, to perform. As mentioned, the user may set an unlock password defined by a series of unlock gestures: 1) the user lifts the UE above his head; 2) the user spins around twice; 3) the user coughs into the UE; 4) the user slaps the bottom of the UE; 5) the user does a finger-pop from his mouth; and 6) the user yells “Aaaaaaaaaahhhh!” Once these gestures are received via the sensors and interpreted, the corresponding action may be performed.

At step 306, at least a portion of the UE is unlocked to perform a specific action corresponding to the interpreting. In some aspects, and continuing the example above, the specific action unlocks the UE. In some aspects, the specific action opens a specific application on the UE. In some aspects, the specific action causes the UE to communicate information to another device. In some aspects, the specific action causes fake information to be displayed on the UE. In some aspects, the specific action causes sensitive information to be encrypted or unavailable. In some aspects, the specific action blocks a portion of functionality of the UE.

Referring now to FIG. 4, a diagram is depicted of an exemplary computing environment suitable for use in implementations of the present disclosure. In particular, the exemplary computer environment is shown and designated generally as computing device 400. Computing device 400 is but one example of a suitable computing environment and is not intended to suggest any limitation as to the scope of use or functionality of the invention. Neither should computing device 400 be interpreted as having any dependency or requirement relating to any one or combination of components illustrated.

The implementations of the present disclosure may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 4, computing device 400 includes bus 402 that directly or indirectly couples the following devices: memory 404, one or more processors 406, one or more presentation components 408, input/output (I/O) ports 410, I/O components 412, power supply 414 and radio(s) 416. Bus 402 represents what may be one or more busses (such as an address bus, data bus, or combination thereof). Although the devices of FIG. 4 are shown with lines for the sake of clarity, in reality, delineating various components is not so clear, and metaphorically, the lines would more accurately be grey and fuzzy. For example, one may consider a presentation component, such as a display device to be one of I/O components 412. Also, processors, such as one or more processors 406, have memory. The present disclosure hereof recognizes that such is the nature of the art, and reiterates that FIG. 4 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 4 and refer to “computer” or “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 404 includes computer-storage media in the form of volatile and/or nonvolatile memory. Memory 404 may be removable, non-removable, or a combination thereof. Exemplary memory includes solid-state memory, hard drives, optical-disc drives, etc. Computing device 400 includes one or more processors 406 that read data from various entities, such as bus 402, memory 404, or I/O components 412. One or more presentation components 408 presents data indications to a person or other device. Exemplary one or more presentation components 408 include a display device, speaker, printing component, vibrating component, etc. I/O ports 410 allow computing device 400 to be logically coupled to other devices, including I/O components 412, some of which may be built in computing device 400. Illustrative I/O components 412 include a microphone, joystick, game pad, satellite dish, scanner, printer, wireless device, etc.

Radio 416 represents a radio that facilitates communication with a wireless telecommunications network. Illustrative wireless telecommunications technologies include CDMA, GPRS, TDMA, GSM, and the like. Radio 416 might additionally or alternatively facilitate other types of wireless communications including Wi-Fi, WiMAX, LTE, or other VoIP communications. As can be appreciated, in various embodiments, radio 416 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. One or more computer-readable media having computer-executable instructions embodied thereon that, when executed, perform a method for leveraging physical state changes of a user equipment (UE) for authentication, the method comprising:
receiving, via one or more sensors of the UE, a series of unlock gestures, the series of unlock gestures comprising a plurality of physical state changes;
interpreting the series of unlock gestures at the UE; and
unlocking at least a portion of the UE to perform a specific action corresponding to the interpreting.

2. The media of claim 1, further comprising, based on the interpreting, selecting the specific action to perform.

3. The media of claim 1, further comprising performing the specific action opens an application on the UE.

4. The media of claim 1, further comprising performing the specific action causes the UE to communicate information to another device.

5. The media of claim 1, further comprising performing the specific action causes fake information to be displayed by the UE.

6. The media of claim 1, further comprising performing the specific action causes sensitive information to be encrypted or unavailable.

7. The media of claim 1, further comprising performing the specific action blocks a portion of functionality of the UE.

8. The media of claim 1, wherein the physical state changes comprise one or more of detecting location of the UE, changes to movement of the UE, changes to orientation of the UE, contact with the UE, audible signals, and or light.

9. A method for leveraging physical state changes of a user equipment (UE) for authentication, the method comprising:
receiving, via one or more sensors of the UE, a series of unlock gestures, the series of unlock gestures comprising a plurality of physical state changes;
interpreting the series of unlock gestures at the UE; and
unlocking at least a portion of the UE to perform a specific action corresponding to the interpreting.

10. The method of claim 9, further comprising, based on the interpreting, selecting the specific action to perform.

11. The method of claim 9, further comprising performing the specific action opens an application on the UE.

12. The method of claim 9, further comprising performing the specific action causes the UE to communicate information to another device.

13. The method of claim 9, further comprising performing the specific action causes fake information to be displayed by the UE.

14. The method of claim 9, further comprising performing the specific action causes sensitive information to be encrypted or unavailable.

15. The method of claim 9, further comprising performing the specific action blocks a portion of functionality of the UE.

16. The method of claim 9, wherein the physical state changes comprise one or more of detecting location of the UE, changes to movement of the UE, changes to orientation of the UE, contact with the UE, audible signals, and or light.

17. A system for leveraging physical state changes of user equipment (UE) for authentication, the system comprising:
at least one processor; and
one or more computer storage media storing computer-readable instructions that when executed by the at least one processor, cause the at least one processor to perform operations comprising:
receiving, via one or more sensors of the UE, a series of unlock gestures, the series of unlock gestures comprising a plurality of physical state changes;
interpreting the series of unlock gestures at the UE;
selecting a specific action corresponding to the interpreting, the specific action comprising one of unlocking the UE, opening an application on the UE, causing the UE to communicate information to another device, causing fake information to be displayed by the UE, causing sensitive information to be encrypted or unavailable, or blocking a portion of functionality of the UE; and
performing the specific action.

18. The system of claim 17, wherein the physical state changes comprise one or more of detecting a location of the UE, detecting changes to movement of the UE, or detecting changes to an orientation of the UE.

19. The system of claim 17, wherein the physical state changes comprise detecting contact with the UE.

20. The system of claim 17, wherein the physical state changes comprises one or more of detecting a volume of audible signals or an intensity of light.
